(19) United States
(12) Patent Application Publication
(10) Pub. No.: US 2013/0062960 A1
(43) Pub. Date: Mar. 14, 2013

(54) SYSTEM AND METHOD FOR CONTROLLING THE CONNECTION FROM A POWER SUPPLY TO AN INDUCTIVE POWER OUTLET

(71) Applicants: Arik Rofe, Jerusalem (IL); Amir Ben-Shalom, Modiin (IL); Oola Greenwald, Mevasseret Zion (IL)

(72) Inventors: Arik Rofe, Jerusalem (IL); Amir Ben-Shalom, Modiin (IL); Oola Greenwald, Mevasseret Zion (IL)

(73) Assignee: POWERMAT TECHNOLOGIES LTD., Neve Ilan (IL)

(21) Appl. No.: 13/513,589

(22) PCT Filed: Dec. 2, 2010
(86) PCT No.: PCT/IL2010/001013

§ 371 Date: Aug. 7, 2012

Related U.S. Application Data
(60) Provisional application No. 61/266,539, filed on Dec. 4, 2009.

(51) Int. Cl. H01F 38/14

(52) U.S. Cl. 307/104

(57) ABSTRACT

A switching system configured to control a connection between a power supply and an inductive power outlet where the inductive power outlet includes at least one primary inductor configured to inductively couple with a secondary inductor associated with an inductive power receiver includes a circuit breaker configured to disconnect the inductive power outlet from the power supply, and a trigger switch configured to disable the circuit breaker when the inductive power receiver is brought into proximity with the inductive power outlet.

### FIELD OF THE INVENTION

The present invention relates to energy efficient power transmission systems. More specifically, the invention relates to systems and methods for controlling power supply to inductive power outlets.

### BACKGROUND

The efficient use of available energy is of great importance for a number of reasons. On a global scale, there is increasing concern that the emission of greenhouse gases such as carbon dioxide from the burning of fossil fuels may precipitate global warming. Moreover, energy resources are limited. The scarcity of global energy resources alongside geopolitical factors drives the cost of energy upwards. Thus efficient use of energy is an ever more important budget consideration for the energy consumer.

Energy losses in electrical energy transmission are chiefly due to the incidental heating of current carrying wires. In many cases this is unavoidable, as current carrying wires are essential for the powering of electrical devices and current carrying wires have resistance. It is the work done to overcome this resistance which generates heat in the wires.

In other cases the energy losses are unnecessary. For example, electrical devices are often left running unnecessarily and energy used to power devices which are not being used is truly wasted. Various initiatives aimed at reducing the amount of energy wasted by idle devices have been proposed. For example, Energy Star is a joint program of the United States Environmental Protection Agency and the United States Department of Energy which awards manufacturers the right to display a recognizable label on products which meet certain energy consumption standards. Energy Star attempts to reduce energy consumption through better energy management.

Efficient energy management reduces energy wastage. For example, laptop computers, which rely upon a limited amount of energy supplied from onboard power cells, use a variety of strategies for keeping power consumption to a minimum. Thus, the screen and hard drives are switched off automatically after the computer has been left inactive for a significant length of time, similarly, the network card may be disabled when the computer is disconnected from the mains or from a network. Such energy management strategies may serve to increase the length of time that a device can be powered by its onboard cells.

Even when connected to the mains, however, efficient use of energy is essential. Many common electrical devices run on low voltage DC and typically use a transformer with an AC-DC power adapter to control the power provided to it. Energy Star estimates that 1.5 billion such power adapters are used in the United States alone for devices such as MP3 players, Personal Digital Assistants (PDAs), camcorders, digital cameras, emergency lights, cordless and mobile phones. According to Energy Star, such power adapters draw about 300 billion kilowatt-hours of energy every year which is approximately 11% of the United States' national electric bill.

Inductive power transmission systems are a convenient power provision alternative to common plug and socket power connections. Inductive power transmission allows power to be transferred from an inductive power outlet to an inductive power receiver with no connecting wires.

An oscillating electrical potential, or driving voltage, is applied across a primary inductor associated with the inductive power outlet. This produces a varying magnetic field in the vicinity of the primary inductor. When the inductive receiver is brought near the inductive outlet, a secondary potential difference, or output voltage, is generated across a secondary inductor positioned within this varying magnetic field. The output voltage may be used to charge or power electrical devices wired to the secondary inductor.

For energy efficient inductive power transmission, the systems which utilize this technology must minimize the amount of energy lost during operation. PCT patent application publication number WO 2008/137996 titled “System and Method for Inductive Charging of Portable Devices” to Partovi, describes an inductive power supply surface which has planar conductive contact pads on a flexible material film. If a receiver coil with a magnet attached is brought close to the pad the contacts connect to ports of transmission coils so that current can flow to the appropriate coil. It will be appreciated that the flexible coil contacts of Partovi's system, which are directed towards detecting the appropriate coil, do not increase the energy efficiency of the system. Indeed, WO 2008/137996 itself points out (para [00283]) the system is designed to allow the charging of a single device and if two devices are placed upon the mat the two devices may not reach the specified power.

Another inductive power transmission system is described in U.S. Pat. No. 7,164,255 to Hui, titled “Inductive battery charger system with primary transformer windings formed in a multilayer structure”. Hui describes another inductive power transfer system in which mechanical switches may be provided. When closed by a secondary charging module, the switches activate the primary winding to the high-frequency AC voltage source. Hui's system, however, introduces moving parts and requires a precise alignment between the secondary charging module and the mechanical switches and therefore compromises much of the advantages integral to inductive power systems.

The need remains, therefore, for energy efficient inductive power transfer systems. Embodiments described herein address this need.

### SUMMARY OF THE EMBODIMENTS

The system described herein relates to a switching system configured to control a connection between a power supply and an inductive power outlet. The inductive power outlet comprises at least one primary inductor configured to inductively couple with a secondary inductor associated with an inductive power receiver, wherein the switching system comprises: a circuit breaker configured to disconnect the inductive power outlet from the power supply, and a trigger switch configured to disable the circuit breaker when the inductive power receiver is brought into proximity with the inductive power outlet.

Optionally, the trigger switch comprises a magnetic switch configured to detect a magnetic element associated with the inductive power receiver. The magnetic switch may comprise at least one reed switch. Alternatively or additionally, the magnetic switch may comprise at least one Hall effect switch.

In other systems, the trigger switch comprises a detector configured to detect an activation signal. Optionally, the detector is configured to detect at least one of a group consisting of: mechanical signals, audio signals, ultra-sonic signals and microwaves.

According to some systems, the trigger switch is configured to detect an activation signal emitted by the inductive power receiver. Optionally, the detector comprises an optical detector configured to detect an optical signal.

Where appropriate, the switching system may further comprise a power source for powering the trigger switch. Such a power source may be selected from a group consisting of electrochemical cells, capacitors, piezoelectric crystals, solar cells, thermoelectric generators, electromagnetic generators and radio-frequency electromagnetic radiation harvesters. Optionally, the inductive power outlet comprises at least one piezoelectric crystal configured to generate an electric potential when compressed by the inductive power receiver.

Additionally, the switching system may further comprise an authentication system configured to confirm the presence of the inductive power receiver when the circuit breaker is disabled. Typically, the circuit breaker is configured to disconnect the inductive power outlet from the power supply after a time period unless the authentication system confirms the presence of the inductive power receiver.

Optionally, the trigger switch comprises a photovoltaic cell. Typically but not exclusively, the photovoltaic cell may be configured to provide an electrical potential and the circuit breaker is configured to be disabled when the electrical potential is below a threshold value.

In various systems, the inductive power outlet comprises a driving unit configured to provide an oscillating voltage across the primary inductor. In further embodiments, the inductive power outlet comprises a communication line from the trigger switch to the circuit breaker.

In addition, a method is taught for controlling a connection between a power supply and an inductive power outlet, the method comprising the following steps: step (a)—providing a circuit breaker between the power supply and the power outlet; step (b)—providing a trigger switch configured to disable the circuit breaker; step (c)—the trigger switch detecting an activation signal; step (d)—the trigger switch sending a disablement signal to the circuit breaker; and step (e)—the circuit breaker connecting the power supply to the inductive power outlet. Optionally, the method may include the additional steps: step (f)—waiting for an authentication signal from an inductive power receiver; and step (g)—if no authentication signal is received, the circuit breaker disconnecting the power supply from the inductive power outlet. Still other embodiments of the method include the additional steps: step (h)—the inductive power outlet receiving an end-of-charge signal from an inductive power receiver; and step (i)—the circuit breaker disconnecting the power supply from the inductive power outlet.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion only, and are presented in the cause of providing what is believed to be the most useful and readily understood description of the principles and conceptual aspects of the embodiments. In this regard, no attempt is made to show structural details of the embodiments in more detail than is necessary for a fundamental understanding; the description taken with the drawings making apparent to those skilled in the art how the several forms of the invention may be embodied in practice. In the accompanying drawings:

FIGS. 1a-b are schematic representations of an inductive power transmitter and inductive power receiver for use in an inductive power transmission system;

FIG. 2a is a block diagram representing the main elements in a first switching system for controlling the connection between a power supply and an inductive power transmitter of an inductive power transfer system;

FIG. 2b is a block diagram representing the main elements of another switching system in which the trigger mechanism is configured to detect activation signals emitted by the inductive receiver;

FIGS. 3a-h are block diagrams schematically representing various trigger mechanisms for use with switching systems;

FIG. 3i is a circuit diagram showing the electrical components of an exemplary sound-activated trigger mechanism;

FIG. 4a is a block diagram showing the main elements of an authentication system for use with switching systems;

FIGS. 4b-f are schematic representations of various authentication systems for use with switching systems; and

FIG. 5 is a flowchart showing the steps of a method for controlling the connection between a power supply and an inductive power transmitter using an embodiment of the switching system.

### DETAILED DESCRIPTION OF SELECTED EMBODIMENTS

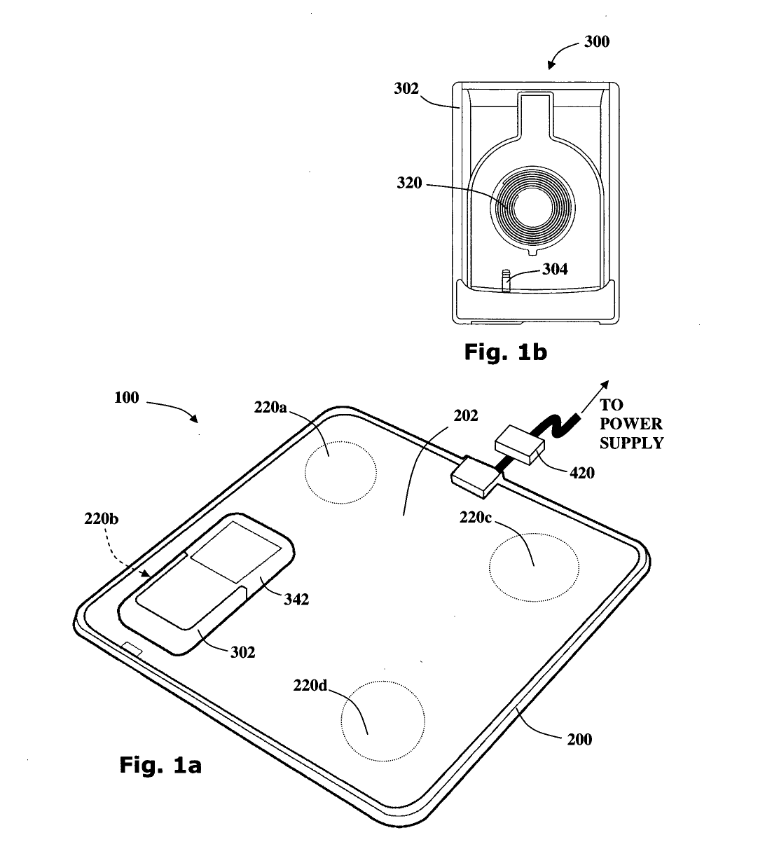

Reference is now made to FIGS. 1a and 1b showing an embodiment of an inductive power transfer system 100. The transfer system 100 includes an inductive power outlet 200 and an inductive power receiver 300. The inductive power outlet 200 is configured to transmit power to the inductive power receiver 300 wirelessly using electromagnetic induction.

The inductive power outlet 200 of the embodiment includes four primary inductors 220a-d incorporated within a platform 202. The inductive power receiver 300 includes a secondary inductor 320 incorporated within a case 302 for accommodating a mobile telephone 342. When a mobile telephone 342 is placed within the case 302 a power connector 304 electrically connects the secondary inductor 320 with the mobile telephone 342. As shown in FIG. 1a, the inductive power receiver 300 may be placed upon the platform 202 in alignment with one of the primary inductors 220b so that the secondary inductor 320 inductively couples with the primary inductor 220b.

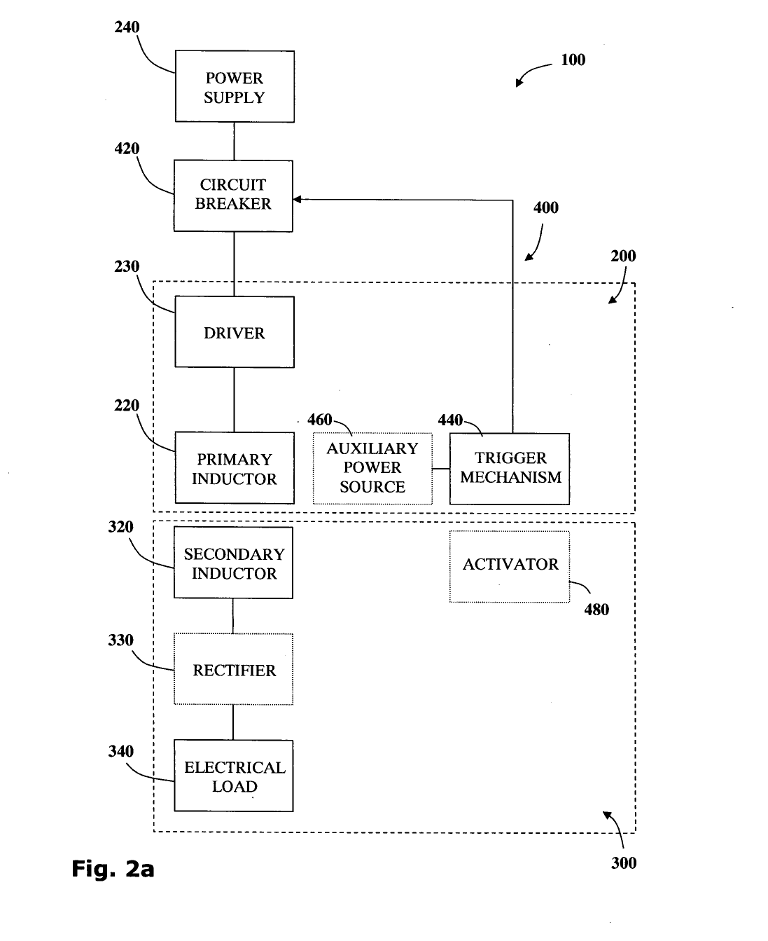

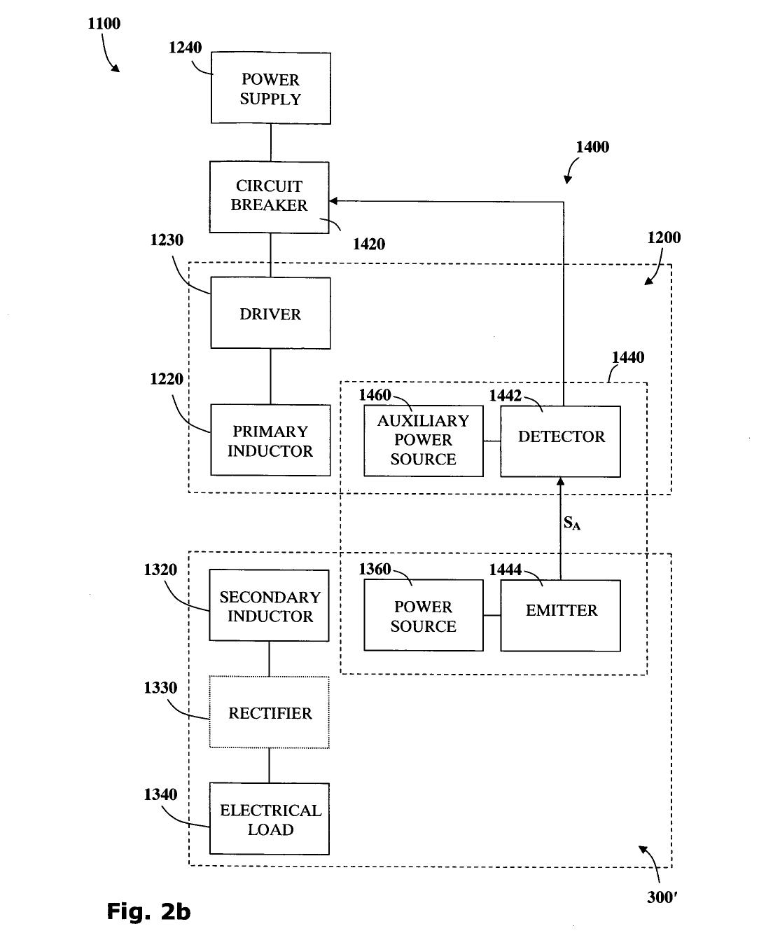

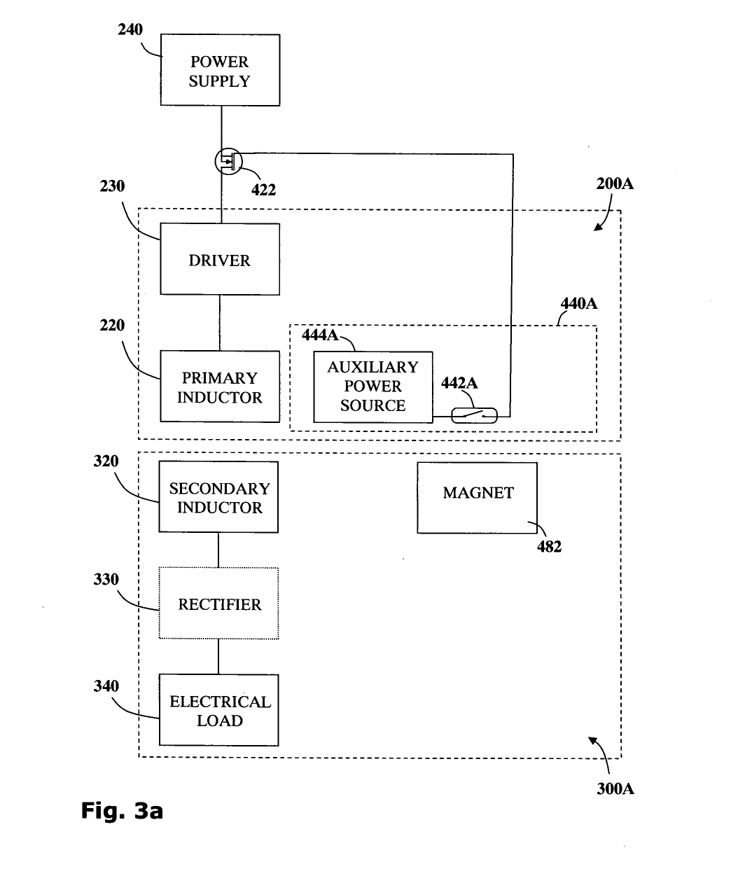

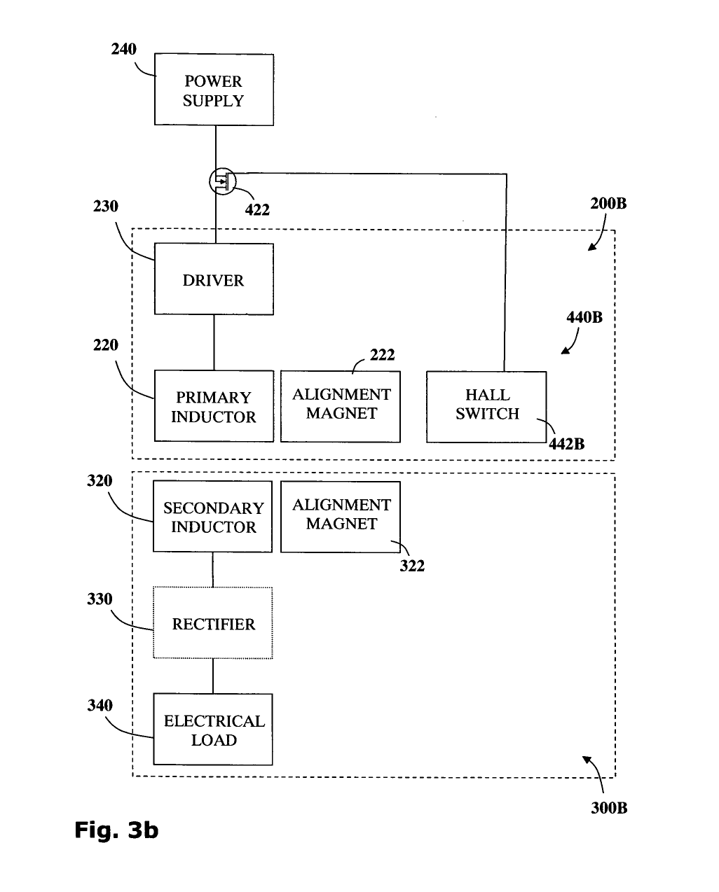

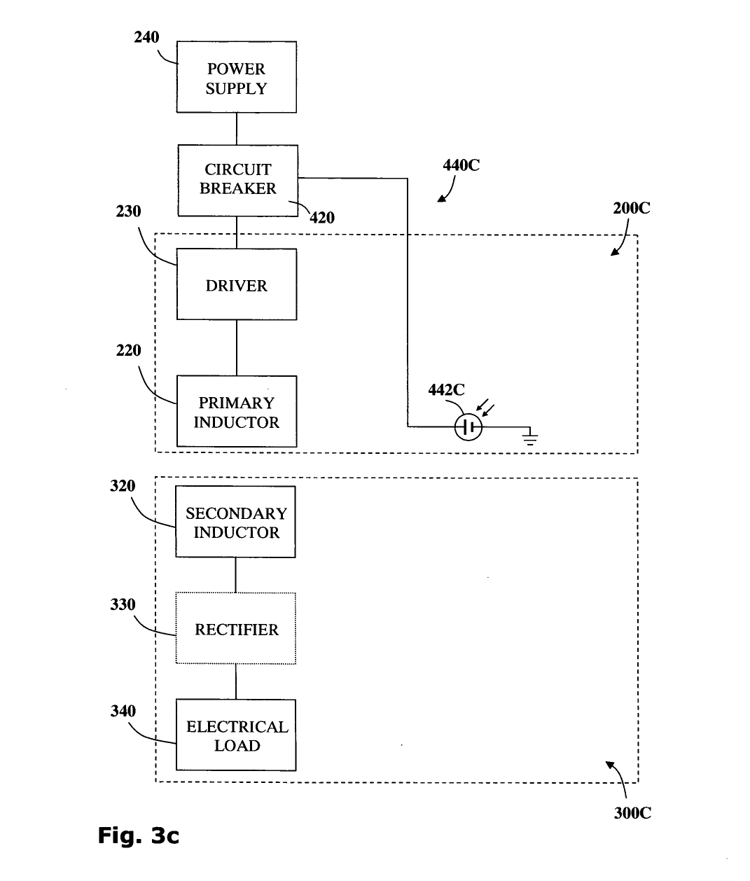

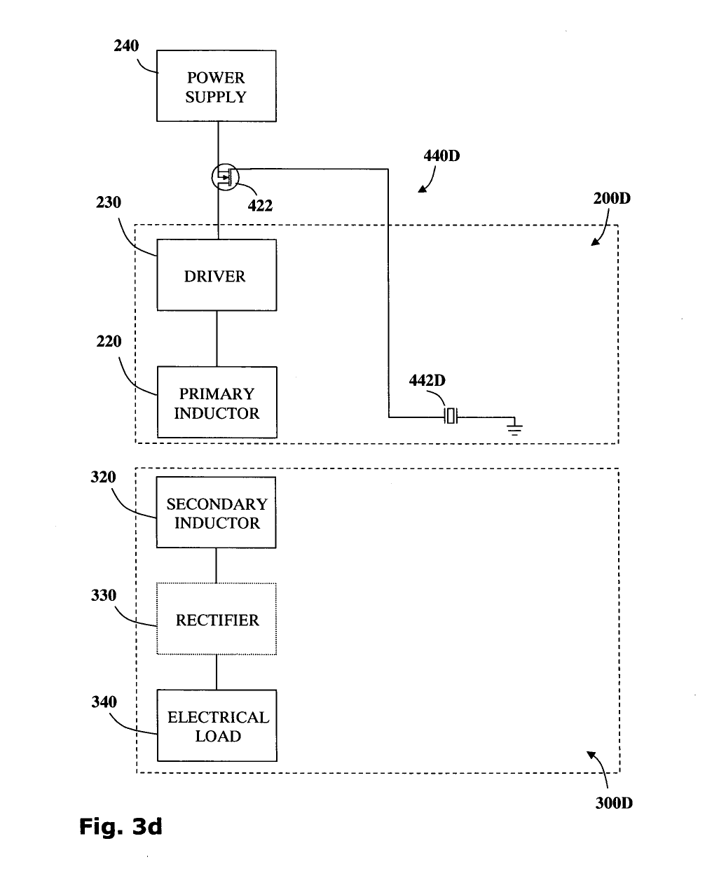

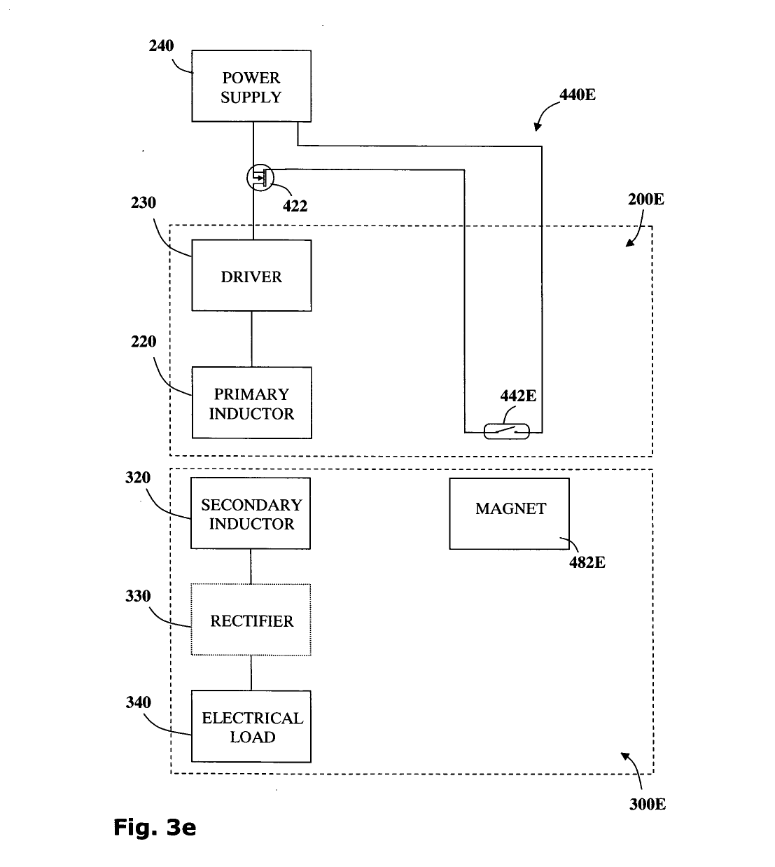

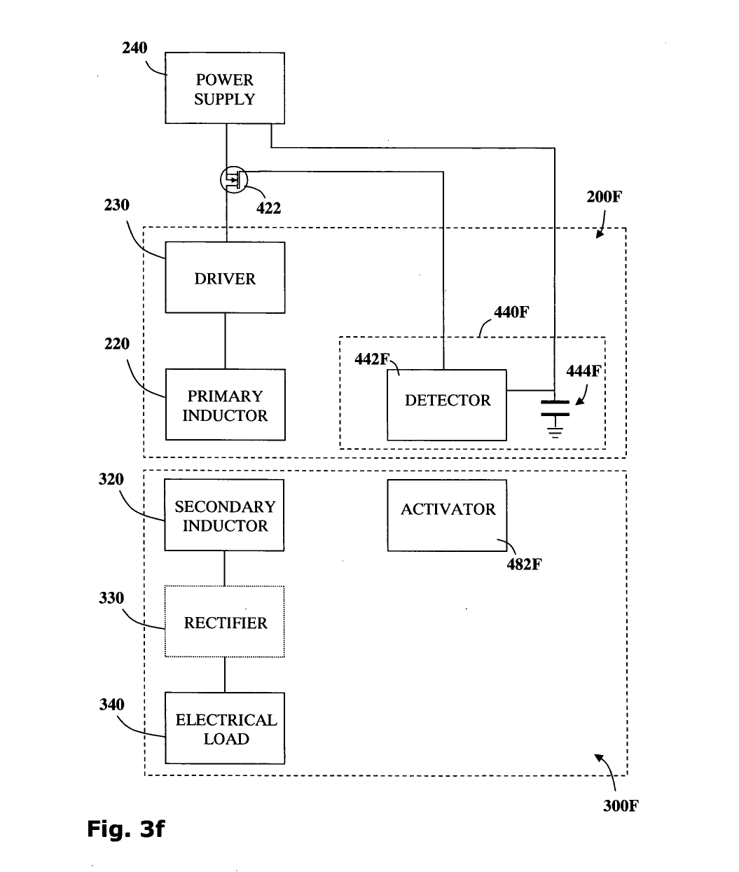

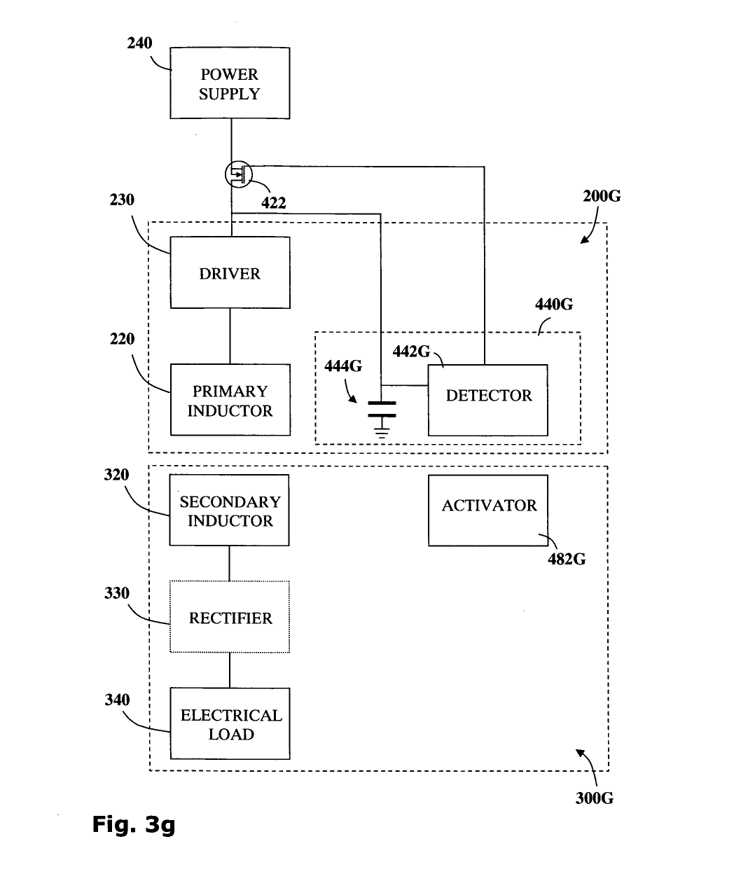

It is noted that in alternative embodiments, inductive power receivers 300 may be otherwise configured, for example, being incorporated within powerpacks for charging power cells or being wired directly to electrical loads 340 (FIGS. 2a, 3a-h) for powering such loads directly. In still other embodiments of the inductive power receiver 300, dedicated inductive power adaptors are provided for connecting to electrical devices by power cables which may be hard wired to the adaptor or connectable via a conductive pin-and-socket connector.

The inductive power outlet 200 is connected to a power supply 240 (FIGS. 2a, 3a-h) from which it may draw power. Often a transformer or an AC-DC power adaptor is introduced between the power supply and the inductive power outlet 200 in order to control power provided thereto. Such power adaptors and transformers may remain connected to the power supply even when the inductive power outlet is idle, which may lead to significant power wastage.

The term ‘power supply’ as used herein refers to the power source from which the inductive power outlet draws energy. Examples of power supplies include: mains lines, electrical generators, power packs, vehicle batteries, power grids, solar cells or the like.

The term ‘power adaptor’ as used herein refers to a device connected to the power supply in order to convert the input voltage source from the power supply into an output voltage of a desired form. Examples of power adaptors may include: transformers, AC-AC converters, AC-DC converters, DC-AC converters, rectification circuits and the like and often combinations thereof.

Typically, the inductive power outlet draws power from the mains via a plug and socket connection, although other power supplies may be used such as vehicle batteries, power packs, generators or the like.

The switching system disclosed herein is directed to reducing unnecessary power wastage by the inductive power outlet or the transformer by breaking their connection to the power supply, such as by disconnecting the mains while the inductive power outlet is idle, for example, when no inductive receiver is coupled thereto or when an electrical device is fully charged.

Accordingly, it is a particular feature of the switching systems described herein that a circuit breaker 420 is provided for controlling the connection between the inductive power outlet 200 and a power supply. It is noted that, where appropriate, the circuit breaker 420 may be introduced between the power supply and a power adaptor to prevent heat losses from a transformer or AC-DC converter while the inductive power outlet is dormant. Alternatively or additionally, the circuit breaker 420 may be introduced between the power adaptor and the inductive power outlet or integrated into the power adaptor itself as appropriate.

The circuit breaker 420 may be configured to disconnect the inductive power outlet 200 from the power supply such that, when inactive, no current is drawn by the power outlet 200 from the power supply. By reducing to zero the current drawn, no power can be drawn by the dormant power outlet 200 thereby significantly reducing power wastage.

Accordingly, the circuit breaker 420 may disconnect the power supply when no inductive power receiver 300 is present and when an inductive power receiver 300 is brought into proximity with one of the primary inductors 220a-d the circuit breaker 420 is disabled, thereby allowing current to flow from the power supply 240 to the power outlet 200. The circuit breaker 420 may be further configured to disconnect the inductive power outlet 200 from the power supply when an inductive power receiver 300 is aligned to a primary inductor 220a-d but is not drawing power from the inductive outlet 200.

For example, an inactive inductive power outlet 200 may remain in its dormant configuration until an inductive power receiver 300 is placed thereupon thereby triggering an activation signal. A switching system 400 and 1400 in FIGS. 2a and 2b, respectively, and as described in further detail below, may be provided such that when an inductive power receiver 300 is brought into alignment with a primary inductor 220b in the power outlet 200, the circuit breaker 420 is disabled. Once disabled, the circuit breaker 420 provides a conductive path such that current may be drawn from the power supply 240 to the inductive power outlet 200.

A telephone 342 or the like may be charged by drawing power by electromagnetic induction from the primary inductor 220b via the secondary inductor 320. Once the electrochemical cell of the telephone 342 is fully charged, an end-of-charge signal may be sent to the inductive outlet 200. Upon receipt of the end-of-charge signal, the switching system 400 may activate the circuit breaker 420 thereby disconnecting the power supply from the inductive power outlet 200 and returning the inductive power outlet into its dormant configuration.

Optionally, the circuit breaker 420 may be further configured to connect the power supply 240 to the inductive power outlet 200 periodically to monitor the charge status of the telephone 342 and to top up power when necessary. Alternatively, the inductive power outlet 200 may remain in its dormant state until another activation signal is triggered.

To better understand embodiments of the switching system 400, reference is now made to the block diagram of FIG. 2a. The block diagram represents the main elements in a first embodiment of the switching system 400 for controlling the connection between a power supply 240, such as the mains, vehicle battery or the like, and an inductive power outlet 200 of an inductive power transfer system 100.

The inductive power transfer system 100 includes an inductive power outlet 200 and an inductive power receiver 300. The inductive power outlet 200 includes a primary inductive coil 220 connectable to the power supply 240 via a driver 230 and optionally via a transformer (not shown). The driver 230 provides the electronics necessary for supplying an oscillating voltage to the inductive coil 220. The inductive power receiver 300 typically includes a secondary inductive coil 320, a rectifier 330 and an electrical load 340. The secondary inductive coil 320 is configured to inductively couple with the primary inductive coil 220 of the inductive power outlet 200. Where required, the rectifier 330 may be provided to convert alternating current induced across the secondary coil 320 to a direct current signal for supplying the electrical load 340. A rectifier 330 may be necessary, for example, where the electrical load 340 comprises an electrochemical cell to be charged.

The switching system 400 is provided to control the connection between the power supply 240 and the inductive power outlet 200. The switching system 400 includes a circuit breaker 420 and a trigger mechanism 440. Optionally, the switching system 400 may further include an auxiliary power source 460 for providing power when the inductive power outlet 200 is disconnected from its power supply 240.

The trigger mechanism 440 is configured to detect an activation signal indicating the proximity of an inductive power receiver 300. The trigger mechanism 440 is further configured to disable the circuit breaker 420 when the activation signal is detected. Optionally, an activator 480 incorporated into the inductive power receiver 300 is configured to produce an activation signal which is detectable by the trigger mechanism 440, as described in greater detail below.

The circuit breaker 420 is configured to receive a disabling signal from the trigger mechanism and in response to provide an electrical connection between the power supply 240 and the inductive power outlet 200. Various circuit breakers 420 may be used to disconnect the inductive power outlet 200 from the power supply 240 as suit requirements. For example, an electronic switch may be provided such as a Metal-Oxide Semiconductor Field-Effect Transistor (MOSFET) or the like the gate terminal of which may be configured to receive the electrical signals sent by the trigger mechanism 440. Other circuit breakers may include for example, a single pole switch, a double pole switch, a throw switch or the like.

Referring now to FIG. 2b, a block diagram is shown representing the main elements of a second embodiment of a switching system 1400. The second embodiment of the switching system 1400 is again configured to control the connection between a power supply 1240 and an inductive power outlet 1200 of an inductive power transfer system 1100. It is a particular feature of the second embodiment of the switching system that the trigger mechanism 1440 includes an activation signal detector 1442 configured to receive activation signals S_{A} emitted actively by a signal emitter 1444 associated with the inductive power receiver 300′.

Various signal emitters as known in the art may be used in embodiments of the active trigger mechanism 1440. Activation signal emitter 1444 may be configured to emit, amongst others, mechanical signals, audio signals, ultra-sonic signals, electromagnetic signals, infrared signals, radio signals or the like. Typically, the activation signal emitter 1444 would require an additional power source 1360, such as an electrochemical cell, to be incorporated into the inductive power receiver 300′.

Where the inductive power receiver 300′ is separated from the inductive power outlet 1200 by an intermediate material, the activation signal S_{A} is selected to be detectable by the signal detector 1442 associated with the inductive power outlet 1200. By way of a non limiting example only, many materials are partially translucent to infrared light. It has been found that relatively low intensity infrared signals from LEDs and the like, penetrate several hundred microns of common materials such as plastic, cardboard, Formica or paper sheet, to a sufficient degree that an optical detector, such as a photodiode, a phototransistor, a light dependent resistor or the like, behind a sheet of from 0.1 mm to 2 mm of such materials, can receive and process the signal. For example, a signal from an Avago HSDL-4420 LED transmitting at 850 nm over 24 degrees, may be detected by an Everlight PD15-22C-TR8 NPN photodiode, from behind a 0.8 mm Formica sheet. For signaling purposes, a high degree of attenuation may be tolerated, and penetration of only a small fraction, say 0.1% of the transmitted signal intensity may be sufficient.

Reference is now made to FIGS. 3a-h showing schematic representations of various trigger mechanisms 440A-H for use with embodiments of the switching system. With particular reference to FIG. 3a, a first embodiment of a magnetic trigger mechanism 440A includes a reed switch 442A and an auxiliary power source 444A.

A magnetic element 482 associated with the inductive power receiver 300A serves as a passive activator. The reed switch 442A of the first embodiment is a magnetic switch selected such that when the magnetic element 482 is brought close to the reed switch 442A, the reed switch 442A closes. The auxiliary power source 444A is thereby connected to the gate terminal of a power MOSFET 422. When the electric signal arrives at the gate terminal of the MOSFET, a conductive path is produced between the source terminal and the drain terminal of the MOSFET 422 thereby connecting the power supply 240 to the inductive power outlet 200A.

Auxiliary power source 444A is selected to provide power to the trigger mechanism 440A when the inductive power outlet is disconnected from its main power supply 240. Various auxiliary power sources 444A may be used in embodiments of the trigger mechanism 440A such as electrochemical cells, capacitors and the like, which may be configured to store energy while the inductive power outlet is connected to the power supply 240 for use when the inductive power outlet is disconnected. Still other auxiliary power sources may include electricity generating elements such as solar cells, piezoelectric elements, dynamos or the like.

An alternative embodiment of the trigger mechanism is shown in FIG. 3b. The second embodiment of the trigger mechanism 440B includes a Hall effect switch 442B. The Hall effect switch 442B may be configured to detect an increase in magnetic field as a result of the approach of an activating magnetic element associated with the inductive power receiver 300B. It will be appreciated that the Hall effect switch 442B of the second embodiment may be preferable over the reed switch 442A of the first embodiment where the trigger mechanism is situated in a fixed magnetic field. This is the case, for example, where a fixed alignment magnet 222 is associated with the primary inductor 220. The Hall effect switch 442B may be configured to detect the approach of a second alignment magnet 322 associated with the inductive power receiver 300B which further functions as the activating magnetic element 482 for the trigger mechanism 440B. It will be further appreciated that other magnetic switches may be used in other embodiments of the trigger mechanism as will occur to the skilled practitioner.

A third embodiment of the trigger mechanism 440C is represented in FIG. 3c. The third embodiment of the trigger mechanism 440C includes a photovoltaic cell 442C which converts light into electrical energy thereby generating an electrical signal. When the inductive power receiver 300C is aligned to the inductive power outlet 200C, light incident upon the photovoltaic cell 442C is obscured thereby reducing the potential of the electrical signal sent to the circuit breaker 420. Thus the photovoltaic cell 442C may be used to detect the approach of the inductive power receiver 300C. Accordingly, the circuit breaker 420 may be configured to connect the power supply 240 to the inductive power outlet 200C when the potential of the electrical signal from the photovoltaic cell is below a threshold value.

It is noted that the potential generated by a single photovoltaic cell may be less than the activation voltage of a MOSFET. For example, a typical MOSFET may require an activation voltage of about 4 to 5 volts whereas a photovoltaic cell may produce a potential of under 0.5 volts. In such situations, a plurality of photovoltaic cells may be connected in series to increase the potential generated. Alternatively, an amplification circuit may be used such as an energy harvesting component or the like. Other embodiments may use photodiodes or phototransistors to trigger the circuit breaker.

Still a fourth embodiment of the trigger mechanism is represented in FIG. 3d. The fourth embodiment of the trigger mechanism 440D includes a piezoelectric element 442D which produces an electrical potential when placed under mechanical stress. The piezoelectric element 442D is configured to be stressed when the inductive power receiver 300D is aligned to the primary inductor 220. Consequently, when the inductive power receiver is aligned to the primary inductor 220, an electrical signal is produced which may be used to disable the circuit breaker 420, for example by increasing the potential at the gate terminal of a MOSFET above a threshold value.

Referring now to FIG. 3e, an inductive power outlet 200E is shown having a second embodiment of a magnetic trigger mechanism 440E. Unlike the first magnetic trigger mechanism 440A described hereinabove in relation to FIG. 3a, the second embodiment of the magnetic trigger mechanism 440E includes a reed switch 442E connected to the power supply 240. Optionally the reed switch 442E is connected to the power supply 240 via current limiting components (not shown) such as resistors or the like provided to protect sensitive components such as the reed switch 442E and the MOSFET 422. Other embodiments may use alternative magnetic sensors such as Hall effect switches, for example.

When a magnetic element 482E is brought close to the reed switch 442E of the second embodiment of the magnetic trigger, the reed switch 442E closes. Thus, the power supply 240 is to the gate terminal of a power MOSFET 422 typically, via current limiting or other protective components. Thus an electric signal arrives at the gate terminal of the MOSFET, a conductive path is produced between the source terminal and the drain terminal of the MOSFET 422 and the power supply 240 is connected to the inductive power outlet 200E. It is noted that the inductive power outlet 200E will not draw any current unless triggered by a magnetic element 482E.

With reference now to FIGS. 3f and 3g showing further inductive power outlets 200F, 200G incorporating two alternative embodiments of the trigger mechanism 440F, 440G in which capacitors 444F, 444G are used as auxiliary power sources. Detectors 442F, 442G are configured to provide an activation potential to the MOSFET 422 when activated by a suitable activator 482F, 482G associated with inductive power receivers 300F, 300G.

With particular reference to FIG. 3f, the capacitor 444F is connected to the power supply 240, typically via protective and/or current rectifying components (not shown), bypassing the circuit-breaker MOSFET 422. Accordingly, the capacitor 444F may be charged directly from the power supply 240. It will be appreciated that a very small charging current will typically be drawn initially by a discharged capacitor 444F. Nevertheless, once the capacitor 444F is fully charged, no further current is typically drawn by the inductive power outlet 200F until the detector 442F is activated and power is drawn from the capacitor 444F.

Referring now to FIG. 3g, the capacitor 444G is connected to the power supply 240 via the MOSFET 422, typically via protective and/or current rectifying components (not shown), such that no current may be drawn by the capacitor 444G until the circuit breaker MOSFET 422 connects power supply 240 to the inductive power outlet 200G.

Reference is now made to the block diagram of FIG. 3h showing the main components of still another trigger mechanism 440H. The trigger mechanism 440H may be used to activate the circuit breaker 420H of another switching system incorporated into an inductive power outlet 200H. The trigger mechanism 440H includes a microphone 442H, a chargeable auxiliary power source 444H and a charging circuit 446H.

The microphone 442H is configured to detect the noise produced by the inductive power receiver 300H being placed upon the inductive power outlet 200H. The sound detected by the microphone 442H may trigger the activation of the circuit breaker 420H to connect the power supply 240 to the inductive power outlet 200H, optionally, via a transformer 235.

It will be appreciated that an auxiliary power source 444H may be necessary to power the microphone 442H when the power supply 240 is disconnected from the inductive power outlet 200H. Accordingly, an electrochemical cell, capacitor or the like may provide an internal power store. A charging circuit 446H may be provided to regulate the charging of the auxiliary power source 44414. Where appropriate, the charging circuit 446H may be operable to monitor the charge state of the auxiliary power source 444H while the power outlet 200H is dormant and to periodically reconnect the charging circuit 446H to recharge the rechargeable cell of the auxiliary power source 444H as required.

Referring now to FIG. 3i a circuit diagram is presented showing an exemplary sound-activated trigger mechanism 440I operable to connect an inductive power outlet (not shown) to a power supply 240I. The trigger mechanism 440I includes a microphone 442I, an activator 448I, an auxiliary power source 444I and an auxiliary charging circuit 446I.

An AC power supply 240I, such a mains electricity source, is connected to a power adaptor 235I via a circuit breaker 420I. The power adaptor 235I is configured to convert an AC input from the power supply 240I to a lower voltage DC output suitable for powering the inductive power outlet, typically, but not exclusively, around 18 volt.

The circuit breaker 420I includes a switch 422I and trigger 424I. The trigger 424I is configured to activate the switch 422I to connect the power supply 240I to the power adaptor 235I when it receives an activation signal from the trigger mechanism 440I.

The auxiliary charging circuit 446I is connected to the output of the power adaptor 235I and is operable to charge an auxiliary power source 444I such as a 3 volt power cell. The auxiliary power source 444I provides power to the microphone 442I and activator 448I of the trigger mechanism 440I. Accordingly, even during its dormant state, the microphone 442I is operable to detect sound indicating the presence of an inductive power receiver (not shown).

The activator 448I comprises a sampler 443I, an optocoupler 445I, an active load detector 447I and an auxiliary power source monitor 449I. The optocoupler 445I is connected to the output of the sampler 443I and operable to activate the trigger 424I of the circuit breaker 420I so as to connect the power supply 240I to the power adaptor 235I. The sampler 443I is configured to send an activation signal to the optocoupler 445I at least when sound is detected by the microphone 442I.

The signal produced by the microphone may be a pulse. However, once the activation signal to the optocoupler 445I is initiated, it may be maintained by a prolonged signal produced by the active load detector 447I.

The active load detector 447I is configured to monitor the voltage of the power supplied to the inductive power outlet. Fluctuations in the voltage of the power supplied to the inductive power outlet may indicate the presence of an active load drawing power therefrom. As long as an active load is detected, a signal is sent to the sampler 443I and the activation signal to the optocoupler 445I is maintained.

When the active load ceases to draw power from the inductive power outlet, for example, when a device is fully charged or switched off, the signal from the active load detector 4471 will typically stop thereby cancelling the activation signal to the optocoupler 445I. Consequently, the circuit breaker 420I may disconnect the power supply 240I from the power adaptor 235I when the load is inactive.

The auxiliary power source monitor 449I is configured to monitor the voltage produced by the auxiliary power source 444I and to send a signal to the sampler 443I when the voltage drops below a threshold value. Thus, when the auxiliary power source 444I requires recharging, an activation signal is sent to the optocoupler 445I causing the power supply 240I to be reconnected to the power adaptor 235I until the voltage across the auxiliary power source 444I is above the threshold value.

The circuit diagram of FIG. 3i is provided as an example of a possible sound-activated trigger mechanism 440I. Variations to the circuit of FIG. 3i and alternative components for use in other trigger mechanisms will occur to the practitioner.

It will be appreciated that false triggering of the trigger mechanism may present a potential problem for the switching systems. Apart from stray noises which may trigger sound-activated trigger mechanisms such as described hereinabove in relation to 3h and 3i, the trigger mechanisms 440A, 440B, 440E described hereinabove in relation to FIGS. 3a, 3b and 3e, may be falsely activated by a magnet unassociated with the inductive power receiver being placed in proximity to the magnetic switch.

Similarly, with the embodiment of the trigger mechanism 440C described above in relation to FIG. 3c, the light sensitive trigger mechanism may be falsely activated by a reduction in ambient light. Again, with the embodiment of the trigger mechanism 440D described above in relation to FIG. 3d, the piezoelectric elements may be stressed by other pressure sources thereby falsely activating the switching system.

The problems associated with false triggering may be reduced by the incorporation of a multi-phase initiation process. During a first phase of the initiation, a dormant inductive power outlet 200 may be triggered by a switching system 400 such as those described above. Once triggered, the inductive power outlet 200 is connected to the power supply but remains inactive. During a second phase of the initiation, a secondary authentication system may be used to verify the presence of an inductive power receiver 300. If a legitimate inductive power receiver 300 is detected, the inductive power outlet may be fully activated. Where no legitimate inductive power receiver is detected, the circuit breaker 420 may be configured to disconnect the inductive power outlet from the power supply, perhaps following a time delay.

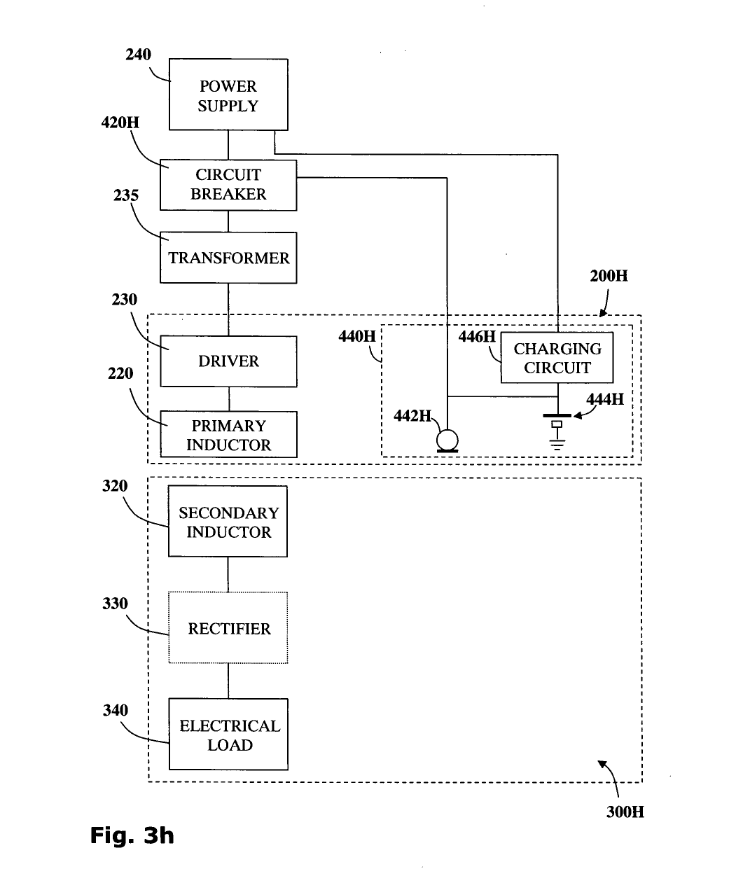

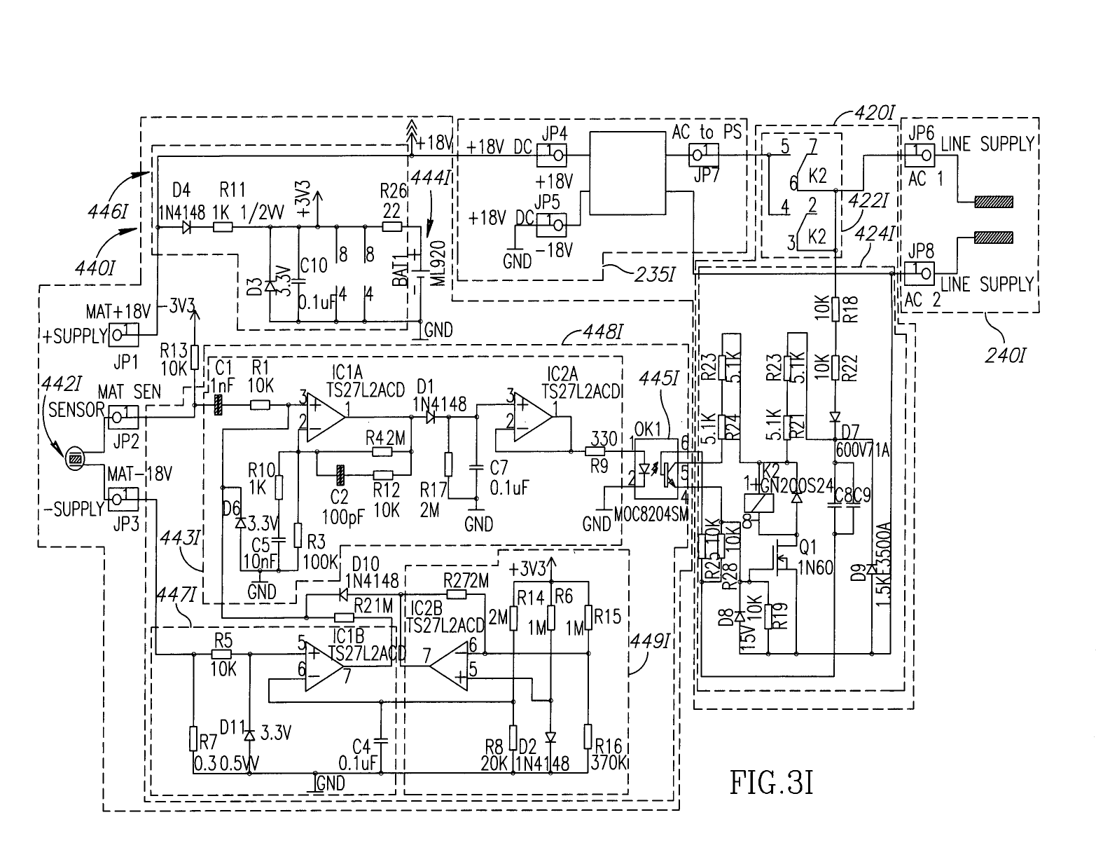

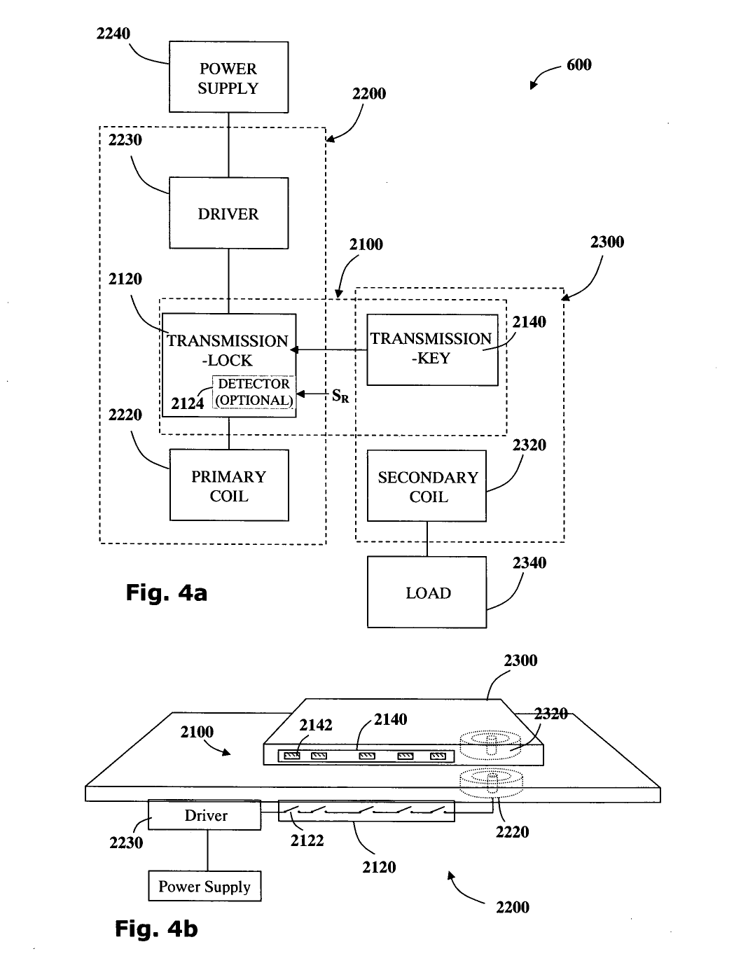

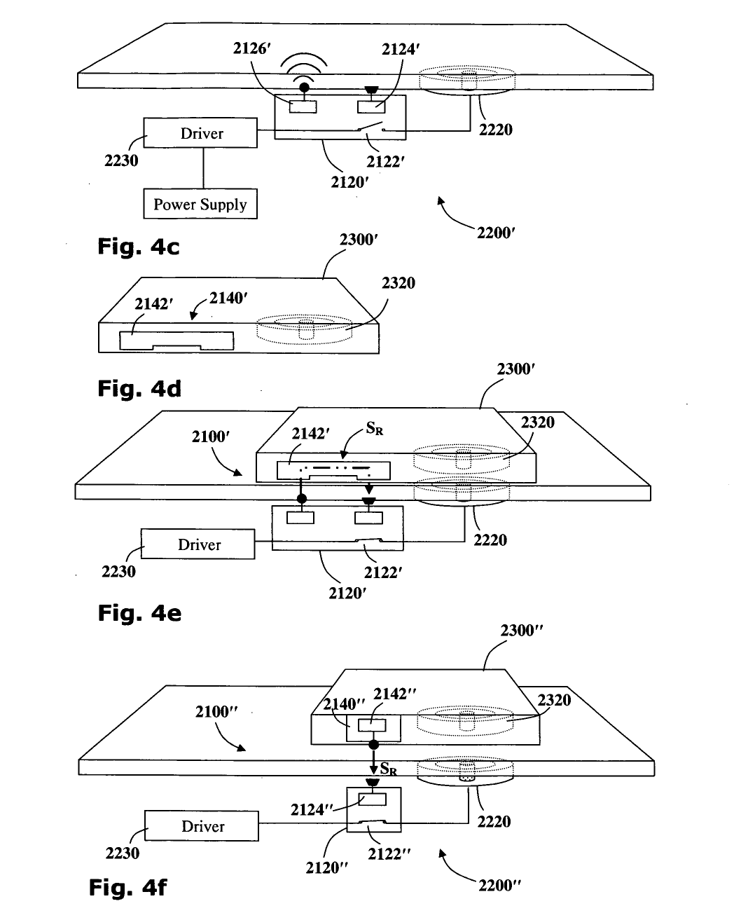

Reference is now made to FIG. 4a which shows an embodiment of an authentication system 600 which may be used in an authentication phase of a multi-phase initiation process. The authentication system 600 is configured to prevent an inductive power outlet 2200 from transmitting power in the absence of a legitimate inductive power receiver 2300.

The inductive power outlet 2200 consists of a primary coil 2220, wired to a power supply 2240, for inductively coupling with a secondary coil 2320 wired to an electrical load 2340. The primary coil 2220 is wired to the power supply 2240 via a driver 2230 which provides the electronics necessary to drive the primary coil 2220. Driving electronics may include a switching unit providing a high frequency oscillating voltage supply, for example. Where the power outlet 2200 consists of more than one primary coil 2220, the driver 2230 may additionally consist of a selector for selecting which primary coil 2220 is to be driven.

The secondary authentication system 600 includes a transmission-guard 2100 consisting of a transmission-lock 2120 connected in series between the power supply 2240 and the primary coil 2220. The transmission-lock 2120 is configured to prevent the primary coil 2220 from connecting to the power supply 2240 unless it is released by a transmission-key 2140. The transmission-key 2140 is associated with the inductive power receiver 2300 and serves to indicate that the secondary coil 2320 is aligned to the primary coil 2220.

With reference to FIG. 4b, a schematic representation is shown of an inductive power outlet 2200 protected by an exemplary magnetic transmission-guard 2100 according to another embodiment of the present invention. Power may only be provided by the protected power outlet 2200 when an authenticated inductive power receiver 2300 is aligned thereto.

The protected power outlet 2200 includes a magnetic transmission-lock 2120 consisting of an array of magnetic switches 2122 electrically connected in series between the primary coil 2220 and the driver 2230. A magnetic transmission-key 2140 consisting of an array of magnetic elements 2142 is provided within the authenticated inductive power receiver 2300.

The configuration of magnetic elements 2142 in the transmission-key 2140 is selected to match the configuration of magnetic switches 2122 in the transmission-lock 2120. The authenticated inductive power receiver 2300 may be aligned with the protected induction outlet 2200 by aligning both the transmission-key 2140 with the transmission-lock 2120 and the secondary coil 2320 with the primary coil 2220. Once correctly aligned, all the magnetic switches 2122 in the transmission-lock 2120 are closed and the driver 2230 is thereby connected to the primary coil 2220.

Various examples of magnetic switches 2122 are known in the art including for example, reed switches, Hall-effect sensors and the like. Such magnetic switches 2122 may be sensitive to any magnetic elements 2142 such as either North or South poles of permanent magnets or electromagnetic coils, for example. It is further noted that Hall-effect sensors may be configured to sense magnetic fields of predetermined strength.

According to certain embodiments, the magnetic transmission-key 2140 may consist of a permanent magnet and a ferromagnetic element incorporated within the inductive power receiver 2300. The characteristics of the magnetic field produced by a transmission-key of this type depend upon the strength and position of the permanent magnetic as well as the dimensions and characteristics of the ferromagnetic element. The magnetic transmission-lock 2120 may consist of an array of magnetic switches, such as unipolar Hall switches, for example, which are strategically placed and orientated such that they connect the primary coil 2220 to the driver 2230 only when triggered by a particular combination of a permanent magnet and ferromagnetic element.

It is noted that permanent magnets may commonly be provided to assist with alignment of the secondary coil 2320 to the primary coil 2220. Ferromagnetic elements may also be commonly included in inductive power receiver 2300 for providing flux guidance from the primary coil 2220 to the secondary coil 2320. The magnetic transmission-lock 2120 may therefore be made sensitive to these components. Indeed a single magnetic transmission-lock 2120 may be provided which is configured to detect various secondary units and to selectively connect more than one primary coil 2220 depending on the secondary unit detected.

Referring back to FIG. 4a, according to other embodiments of the transmission-guard 2100, a power outlet 2200 may be protected by a transmission-lock 2120 which may be released when a release signal S_{R} is received by a detector 2124. The release signal S_{R} may be actively emitted by the transmission-key 2140 or alternatively the transmission-key may passively direct the release signal towards the detector 2124.

One example of a passive transmission-key 2140 is shown in FIGS. 4c-e which represents an optical transmission-guard 2100 according to a further embodiment of the invention.

The transmission-guard 2100 consists of an active optical transmission-lock 2120′ incorporated within an inductive power outlet 2200′ and a passive optical transmission-key 2140′ incorporated within the secondary unit inductive power receiver 2300′.

With particular reference to FIG. 4c, the optical transmission-lock 2120′ includes a switch 2122′, an optical detector 2124′, such as a photodiode, a phototransistor, a light dependent resistor or the like, and an optical emitter 2126′ such as a light emitting diode (LED). The switch 2122′ is normally open but is configured to close when a release signal S_{R} is received by the optical detector 2124′, thereby connecting a primary coil 2220 to a driver 2230. The optical emitter 2126′ is configured to emit the optical release-signal S_{R} which is not directly detectable by the optical detector 2124′.

Referring now to FIG. 4d, the optical transmission-key 2140′ includes a bridging element 2142′ such as an optical wave-guide, optical fiber, reflector or the like. The bridging element 2142′ is configured to direct the optical release-signal S_{R} from the optical emitter 2126′ towards the optical detector 2124′, when a secondary coil 2320 is aligned with the primary coil 2220.

When the secondary unit inductive power receiver 2300′ is correctly aligned with the inductive power outlet 2200′, as shown in FIG. 4e, the secondary coil 2320 aligns with the primary coil 2220 and the passive optical transmission-key 2140′ aligns with the optical transmission-lock 2120′. The optical release-signal S_{R} is thus detected by the optical detector 2124′ and the switch 2122′ is closed connecting the primary coil 2220 to the driver 2230.

As noted above, many materials are partially translucent to infrared light. It has been found that relatively low intensity infrared signals from LEDs and the like, penetrate several hundred microns of common materials such as plastic, cardboard, Formica or paper sheet, to a sufficient degree that an optical detector 2124′, such as a photodiode, a phototransistor, a light dependent resistor or the like, behind a sheet of from 0.1 mm to 2 mm of such materials, can receive and process the signal. For example, a signal from an Avago HSDL-4420 LED transmitting at 850 nm over 24 degrees, may be detected by an Everlight PD15-22C-TR8 NPN photodiode, from behind a 0.8 mm Formica sheet. For signaling purposes, a high degree of attenuation may be tolerated, and penetration of only a small fraction, say 0.1% of the transmitted signal intensity may be sufficient.

Although an optical transmission-key 2140′ is described above, it will be appreciated that other passive transmission-keys may incorporate bridging elements configured to guide release-signals of other types. For example, a ferromagnetic bridge may be incorporated for transmitting a magnetic release-signal from a magnetic element to a magnetic detector such as a Hall-effect sensor or the like. The magnetic emitter in such a case may be the primary coil itself.

Alternatively, audio signals may be guided through dense elements, or low power microwaves along microwave wave guides for example.

An example of an active optical transmission-key 2140″ is shown in FIG. 4f representing a transmission-guard 2100″ according to another embodiment of the invention.

The transmission-guard 2100″ of this embodiment includes a transmission-lock 2120″ incorporated within an inductive power outlet 2200″ and an active optical transmission-key 2140″ incorporated within secondary unit inductive power receiver 2300″.

The active optical transmission-key 2140″ includes an optical emitter 2142″, configured to emit an optical release-signal S_{R}, and the transmission-lock 2120″ includes a switch 2122″ and an optical detector 2124″. The transmission-lock 2120″ is configured to close the switch 2122″ thereby connecting a primary coil 2220 to a driver 2230 when the optical detector 2124″ receives the release-signal S_{R}.

When the secondary unit inductive power receiver 2300′ is aligned with the inductive power outlet 2200″, the transmission-key 2140″ emits an optical release-signal S_{R} which is received by the optical detector 2124″ of the transmission-lock 2120″ and this closes the switch 2122″. Thus, the inductive power outlet 2200″ is enabled to transfer power to the secondary coil 2320.

It will be appreciated that a release signal S_{R} may be coded to provide a unique identifier. Coding may be by modulation of frequency, pulse frequency, amplitude or the like. The code may be used, for example, to identify the type or identity of the secondary unit for authentication. Other data may additionally be encoded into the release-signal. This data may include required power transmission parameters, billing information or other information associated with the use of the power outlet. Although an optical active transmission-key 2140″ is described above, it will be appreciated that other active transmission-keys may emit other types of release-signals. For example, the secondary coil 2320 may be used to transmit a magnetic release-signal to a magnetic detector incorporated in the transmission-lock. This could be a Hall-effect sensor or the like or even the primary coil 2220 itself.

To actively emit a release-signal transmission-keys typically require a power source. In some cases, particularly where the secondary unit is incorporated into a portable electrical device, power may be provided by internal power cells within the secondary unit. Alternatively, power may be drawn from a power pulse transferred from the primary coil to the secondary coil.

In certain embodiments of the invention, the inductive power outlet transfers a periodic low energy power pulse, for example, a pulse of a few milliseconds duration may be transmitted by the primary coil at a frequency of 1 hertz or so. When a secondary coil is brought into the vicinity of the primary coil the power may be transferred to the secondary coil and may be used to power an active transmission-key.

In other embodiments of the transmission-guard, a first transmission-key (preferably a passive transmission-key) associated with the secondary unit inductive power receiver, releases a first transmission-lock thereby indicating the probable presence of a secondary coil. A low energy power pulse is then emitted by the primary coil to power an active second transmission-key which may release a second transmission-lock thereby connecting the primary coil to a driver.

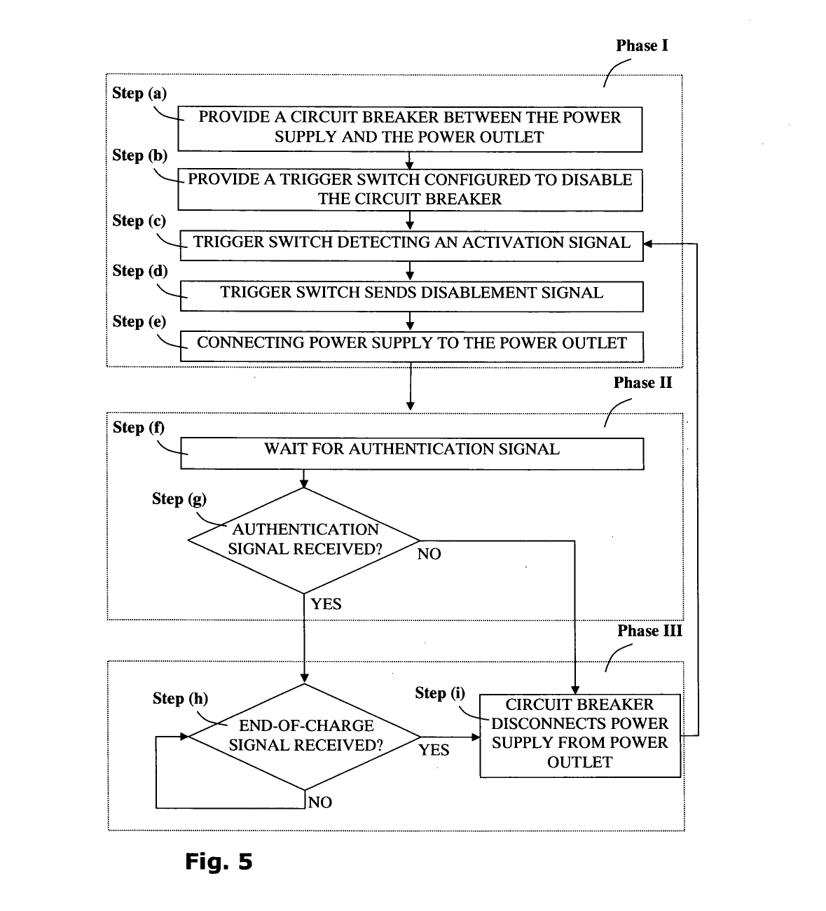

FIG. 5 is a flowchart showing the steps of a method for controlling the connection between a power supply and an inductive power outlet using an embodiment of the switching system.

The method may have a connection phase, an activation phase and a termination phase. The connection phase includes the following steps: step (a)—providing a circuit breaker between the power supply and the power outlet; step (b)—providing a trigger switch configured to disable the circuit breaker; step (c)—the trigger switch detecting an activation signal; step (d)—the trigger switch sending a disablement signal to the circuit breaker; and step (e)—the circuit breaker connecting the power supply to the inductive power outlet.

The activation phase includes the following steps: step (f)—waiting for an authentication signal from an inductive power receiver; and step (g)—verifying the authentication signal such that if no authentication signal is received, the circuit breaker disconnects the power supply from the inductive power outlet.

The termination phase includes the following steps: step (h)—the inductive power outlet receiving an end-of-charge signal from an inductive power receiver; and step (i)—the circuit breaker disconnecting the power supply from the inductive power outlet.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A switching system configured to control a connection between a power supply and an inductive power outlet, the inductive power outlet comprising at least one primary inductor configured to inductively couple with a secondary inductor associated with an inductive power receiver, wherein said switching system comprises:
a circuit breaker configured to disconnect the inductive power outlet from the power supply, and
a trigger switch configured to disable the circuit breaker when the inductive power receiver is brought into proximity with the inductive power outlet.

2. The switching system of claim 1, wherein said trigger switch comprises a magnetic switch configured to detect a magnetic element associated with said inductive power receiver.

3. The switching system of claim 2, wherein said magnetic switch comprises at least one switch selected from the group consisting of a reed switch and a Hall effect switch.

4. (canceled)

5. The switching system of claim 1, wherein said trigger switch comprises a detector configured to detect an activation signal.

6. The switching system of claim 5, wherein said detector is configured to detect at least one signal selected from the group consisting of mechanical signals, audio signals, ultra-sonic signals, optical signals and microwave signals.

7. The switching system of claim 5, wherein said signal is emitted by said inductive power receiver.

8. (canceled)

9. The switching system of claim 1, further comprising a power source for powering said trigger switch.

10. The switching system of claim 7, wherein said power source is selected from the group consisting of electrochemical cells, capacitors, piezoelectric crystals, solar cells, thermoelectric generators, electromagnetic generators and radio-frequency electromagnetic radiation harvesters.

11. The switching system of claim 9, wherein said inductive power outlet comprises at least one piezoelectric crystal configured to generate an electric potential when compressed by said inductive power receiver.

12. The switching system of claim 1, further comprising an authentication system configured to confirm the presence of said inductive power receiver when said circuit breaker is disabled.

13. The switching system of claim 12, wherein said circuit breaker is configured to disconnect said inductive power outlet from the power supply after a time period unless said authentication system confirms the presence of said inductive power receiver.

14. The switching system of claim 1, wherein said trigger switch comprises a photovoltaic cell.

15. The switching system of claim 14, wherein said photovoltaic cell is configured to provide an electrical potential and said circuit breaker is configured to be disabled when said electrical potential is below a threshold value.

16. The switching system of claim 1, wherein said inductive power outlet comprises a driving unit configured to provide an oscillating voltage across said primary inductor.

17. The switching system of claim 1, wherein said inductive power outlet comprises a communication line from said trigger switch to said circuit breaker.

18. The switching system of claim 1, wherein said trigger switch comprises a piezoelectric element.

19. The switching system of claim 1, wherein said trigger switch comprises a microphone.

20. A method for controlling a connection between a power supply and an inductive power outlet, said method comprising the following steps:
step (a)—providing a circuit breaker between said power supply and said power outlet;
step (b)—providing a trigger switch configured to disable said circuit breaker;
step (c)—said trigger switch detecting an activation signal;
step (d)—said trigger switch sending a disablement signal to said circuit breaker; and
step (e)—said circuit breaker connecting said power supply to said inductive power outlet.

21. The method of claim 20, further comprising the additional steps:
step (f)—waiting for an authentication signal from an inductive power receiver; and
step (g)—if no authentication signal is received, said circuit breaker disconnecting said power supply from said inductive power outlet.

22. The method of claim 20, further comprising the additional steps:
step (h)—said inductive power outlet receiving an end-of-charge signal from an inductive power receiver; and
step (i)—said circuit breaker disconnecting said power supply from said inductive power outlet.
